(19) United States
(12) Patent Application Publication
(10) Pub. No.: US 2008/0114707 A1
(43) Pub. Date: May 15, 2008

(54) Taximeter using digital speed or distance as input

(75) Inventor: Philip Steiner, Cote-St-Luc (CA)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: CENTRODYNE INC.

(21) Appl. No.: 11/598,232

(22) Filed: Nov. 13, 2006

(51) Int. Cl. G06F 17/00; G01C 21/02

(52) U.S. Cl. 705/417; 701/213

(57) ABSTRACT

There is provided an electronic taximeter that accepts a digital data input representative of one of a vehicle speed and a distance traveled by the vehicle. The digital data signal may be taken from the electronic engine bus of the vehicle or from the On Board Diagnostic connector. The taximeter has reading means to read the digital data input, timing means to provide timing data and computation means operatively connected to the reading means and the timing means for computing a fare associated with a trip. The computation means can advantageously be provided with speed integration means for integrating the speed data with respect to time, or summation means where the input is a digital distance, in order to determine the distance traveled by the vehicle with an accuracy meeting the regulations.

### FIELD OF THE INVENTION

The present invention generally relates to a taximeter used to compute the fare of a trip in a taxicab, and more particularly concerns an electronic taximeter particularly adapted to calculate the fare directly from a serial bus multi bit digital data signal corresponding to speed or distance data at its input.

### BACKGROUND OF THE INVENTION

Taximeters generally compute fare based on a combination of distance traveled and elapsed time. The distance information is normally taken from a pulse train whose frequency is proportional to speed and each pulse therefore represents a fixed distance traveled.

In the past, such pulse trains were readily available as car manufacturers provided them to be used by the speedometer and odometer among other things.

Today with the dashboards going electronic, digital speedometers and odometers no longer use pulse trains as input signals. Although car manufacturers continue to use distance or speed pulse trains in some sub-systems such as ABS brakes, these signals have become difficult to access and in many cases, car manufacturers do not recommend hooking other devices to these signals.

There are at least three major issues with taximeters using pulse trains as signal input. Firstly, locating and connecting to these pulse trains has become the most difficult part of a taximeter installation. A second more serious problem has arisen from the fact that unscrupulous operators have found a way to cheat taxi passengers. This is achieved by adding extra pulses to the taximeter input, either by direct connection or by radio waves. A third consideration is that these pulse trains have different proportionality constants for each vehicle, that is, the distance represented by each pulse is different from vehicle to vehicle. As a result, the meter needs to be calibrated to match the vehicle, which is generally a time consuming task. A meter where the input is speed or distance data would not require calibration, thereby simplifying the installation process.

Because of the difficulty of finding a suitable pulse train in the vehicle, attempts have been made to provide devices that produce pulses from the digital speed signals available on the vehicle electronic engine bus. This pulse train or waveform is then fed to the taximeter input.

There are several disadvantages to this method. Firstly, the taximeter input still consists of pulses and is therefore susceptible to external modification in order to cheat the customer. Furthermore, the method is costly in that much of the circuitry required to read the bus is already used in the taximeter and is thus being duplicated. Moreover, the digital signal on the bus is being converted to an analog waveform unnecessarily thereby introducing an additional source of inaccuracy since the meter (which is primarily a digital device) needs to convert it back to digital. Additionally, the user has to install two devices instead of one, thereby adding complexity and cost to the installation.

Therefore, in order to overcome most of the above mentioned drawbacks of existing taximeters, it would be advantageous to provide a taximeter that would calculate fare directly from a digital speed or distance signal at its input instead of an electronic pulse train.

### SUMMARY OF THE INVENTION

An object of the present invention is to provide a taximeter that satisfies the above mentioned needs.
Accordingly, there is provided an electronic taximeter for a vehicle using a serial bus multi bit digital data signal providing one of speed data and distance data. The taximeter has a digital input for receiving one of the speed data and the distance data and reading means for reading the digital input. The taximeter is also provided with timing means for providing timing data and computation means operatively connected to the reading means and the timing means for computing a fare associated with a trip. The taximeter also has output means operatively connected to the computation means for outputting the fare. The taximeter also has a power source for powering the taximeter.

Advantageously, the digital input of the taximeter allows the direct use of digital speed or distance signals already available in the vehicle. Currently such signals are available on the electronic vehicle engine bus or on the On Board Diagnostic connector thereof.

In a preferred embodiment, the digital data signal comprises digital speed data, the computation means having speed integration means for integrating the speed data with respect to time to determine the distance traveled by the vehicle with an accuracy meeting the regulations.

### BRIEF DESCRIPTION OF THE DRAWINGS

These and other objects and advantages of the invention will become apparent upon reading the detailed description and upon referring to the drawings in which:

FIG. 1 is a schematic block diagram of a taximeter according to the present invention, which uses digital speed or distance data as its input.

FIG. 2 is a schematic block diagram of a taximeter according to the present invention which uses digital speed data as its input and in particular where the individual speed words may be less accurate than required by the specifications.

FIG. 3 is a schematic block diagram of a taximeter according to the present invention, which uses digital distance as its input and in particular where the individual distance words may be less accurate than required by the specifications.

While the invention will be described in conjunction with example embodiments, it will be understood that it is not intended to limit the scope of the invention to such embodiments. On the contrary, it is intended to cover all alternatives, modifications and equivalents as may be included as defined by the appended claims.

### DESCRIPTION OF A PREFERRED EMBODIMENT

In the following description, similar features in the drawings have been given similar reference numerals and in order to lighten the figures, some elements are not referred to in some figures if they were already identified in a preceding figure.

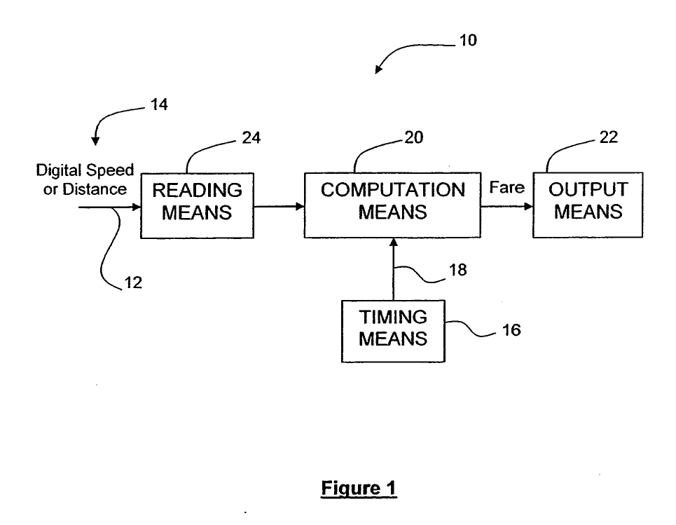

Referring to FIG. 1, there is shown an electronic taximeter 10 for a vehicle (not shown) using a serial bus multi bit digital data signal 14 providing one of speed data and distance data according to the present invention. The electronic taximeter 10, according to the invention, advantageously accepts a digital speed or distance signal at its input. Indeed, the taximeter 10 is provided with a digital input 12 for receiving one of the speed data and the distance data. The taximeter 10 has reading means 24 that are able to accept, read and interpret the digital input 12. The taximeter 10 is also provided with timing means 16 which provide timing data 18. The taximeter 10 also has computation means 20 operatively connected to the reading means 24 and the timing means 18 for computing a fare associated with a trip. The computation means 20 advantageously calculate the distance traveled as well as the fare. The fare may be based on distance or time or both, as required by a particular application. The taximeter 10 also has output means 22 operatively connected to the computation means 20 for outputting the fare. Such output means 22 may consist of display means or printing means or audible means or combinations thereof. The taximeter 10 also has a power source (not shown) for powering the taximeter. Such power source can be embedded in the taximeter 10, or can be provided by the vehicle or can even be external to the vehicle. It should be noted that with current technology it is possible that the reading means 24, the timing means 16, the computation means 20 and even some of the output means 22 may advantageously all be incorporated in a single micro-controller (not shown). Other arrangements can also be considered.

The digital data signal 14 corresponding to the vehicle speed or the distance traveled by the vehicle may be taken from a variety of sources, such as the ones already available in the vehicle. One such source is the electronic engine bus of the vehicle and, in particular, the On Board Diagnostic (OBD) connector. Signals may also be taken from sources external to the vehicle such as GPS (Global Positioning Systems), which provide speed or distance output data. Other external sources providing digital speed or distance data may also be considered.

### Automotive Electronic Engine Bus

The trend today in trucks and cars is to connect many of the systems together via an electronic serial data network for the purpose of sharing data. Using a system bus simplifies vehicle wiring and facilitates the use of microprocessors, giving greater control over performance, emissions, and other vehicle functions. As an example, speed information is sent from the wheels to the electronics, which interprets this data and then sends braking information to the ABS braking system.

All of the new vehicles have an electronic engine bus and most have digital speed and/or distance information available on that bus as it is a key requirement for many of the vehicle's sub-systems.

These signals can then advantageously be connected to and provide an appropriate input for the taximeter 10.

### The On Board Diagnostic Signals

Although digital speed and/or distance is almost always available on the electronic bus, this information is generally proprietary. The data is therefore not standard from one manufacturer to another and may even vary with vehicle models from the same manufacturer. Access to this information therefore requires the cooperation of the manufacturer. The design of the taximeter is also somewhat more complicated as it needs to accommodate a wide range of input signals.

A standard speed signal, also called speed message, is currently available at the “On Board Diagnostics (OBD) connector. This results from the fact that current US regulations require all car manufacturers to provide certain electronic signals that can be used for diagnostic purposes. These output signals, referred to as “On Board Diagnostics (OBD), are completely standardized by the SAE, including the OBD connector, hardware and protocol interface. Although several SAE bus interfaces are currently in use, manufacturers seem to be moving towards SAE J2284 High-Speed Can (HSC), thus providing even more standardization.

One of the mandatory OBD signals is the vehicle speed. The units are in miles per hour (mph) with a resolution of 1 mph for english units or kilometers per hour (kph) and a resolution of 1 kph for metric units. The minimum time between updates is 0.1 seconds.

Providing a taximeter that can use this digital speed signal as its input by connecting directly to the OBD connector has many advantages. Indeed, the signal is well defined by SAE regulations and is easily accessible. Another major advantage is that the power source can also be taken from the OBD. Thus, in this case, the entire electrical installation of the taximeter consists of plugging it to the OBD connector. The only exception would be in hooking up the meter to the dome light where this feature is required.

### Accuracy Considerations for the OBD Speed Signal

The main function of taximeters is to provide a standard fare for customers and to protect them from unscrupulous operators. Fare accuracy is therefore regulated in most jurisdictions and tends to be around 1% for distance. Since most authorities are more concerned with overcharging than undercharging, one can sometimes see different positive and negative accuracy specifications. As an example, the federal US specification is −4%, +1%, as detailed in “Specification, Tolerances, and Other Technical Requirements for Weighing and Measuring Devices, NIST Handbook 44, U.S. Government Printing Office, 2004”. As mentioned therein, distance accuracy is generally defined over a one mile distance.

In examining the OBD speed signal specification, it is not immediately apparent that convenient taximeter accuracies can be achieved with this signal. The resolution of 1 mph, especially at low speeds, seems to prohibit achieving accuracies in the order of 1%. In fact, a resolution of 1 mph implies a maximum error of 0.5 mph for cases where the speed data is rounded to the closest digit. The worst case percent error at say 10 mph would therefore be 5%.

According to the present invention, there are several considerations, however, which make it possible to use this signal and still achieve the required accuracy.

Indeed, in normal driving, it is almost impossible to maintain a perfectly constant fixed speed. In fact, in even the best of conditions, speed variations on the order of several mph are not unexpected. Therefore, as it will be more clearly understood upon reading of the following description, in a preferred embodiment of the present invention, the taximeter advantageously computes distance by performing an integration of speed. Thus, it is not the accuracy of the individual speed samples that matters, but rather the accuracy of the accumulated distance, or sample sum, that will determine the accuracy of the fare calculation in the taximeter.

### For example, consider a course of distance D driven in time Tat a nominal speed of Vₒ. It is well known that

$${V}_{0} = \frac{D}{T} \qquad ( 1 )$$

### Now if the average speed of the vehicle between time iT_{S} and (i+1) T_{S} is given by Vᵢ, then equation (1) can be written as

$${T}_{S} {\sum }_{i = 1}^{N} {V}_{i} = {TV}_{0} = D \qquad ( 2 )$$

Where NT_{S}=T. In reality, the actual speed at any given instant can be modeled as a uniform probability distribution over the range [Vₒ−ΔV_{L}, Vₒ+ΔV_{U}], where the values of the ΔV depend upon a number of factors such as the driver or cruise control system, accelerator response, terrain, etc . . . So equation (2) can be written

$$\begin{matrix}{T}_{S} {\sum }_{i = 1}^{N} {V}_{i} = {T}_{S} {\sum }_{i = 1}^{N} ( {V}_{0} + Δ {V}_{i} ) \\ = {NT}_{S} {V}_{0} + {T}_{S} {\sum }_{i = 1}^{N} Δ {V}_{i} \\ {\sum }_{i = 1}^{N} Δ {V}_{i} = 0\end{matrix} \qquad ( 3 )$$

Our testing has indicated that the tolerance of a typical cruise control system is generally no better than ±1 mph over flat, smooth terrain. It is therefore reasonable to assume a minimum ΔV of ±2 mph for driving performed manually. Now the speed read off of the OBD connector has a rounding error of e=±0.5 mph. We can therefore apply a well known theorem from quantization theory that states that if the variation in speed is significantly larger than the OBD error, then the OBD error can be modeled with a uniform probability distribution. So, at any given instant i, the speed of the OBD sample, V^{OBD}ᵢ is given by:

Vᵢ^{OBD}=V₀+ΔVᵢ+eᵢ (4)

### Now, since the sampling rate is fixed at some constant value Ts we have

$$\begin{matrix}{T}_{S} {\sum }_{i = 1}^{N} {V}_{i}^{OBD} = {NT}_{S} {V}_{0} + {T}_{S} {\sum }_{i = 1}^{N} Δ {V}_{i} + {T}_{S} {\sum }_{i = 1}^{N} {e}_{i} \\ = {NT}_{S} {V}_{0} + {T}_{S} {\sum }_{i = 1}^{N} {e}_{i}\end{matrix} \qquad ( 5 )$$

### Since the second term on the right hand side must be zero from equation (3).

### The OBD rounding error has a uniform distribution on [−0.5,+0.5] and thus we know that the standard deviation of the sample sum above is given by

$$σ = \sqrt{\frac{N}{12}} \qquad ( 6 )$$

Therefore, the error in the distance calculation will have a standard deviation of:

$${σ}_{e} ( \% ) = \frac{\sqrt{N}}{{NV}_{0} \sqrt{12}} = \frac{1}{{V}_{0} \sqrt{12 N}} \qquad ( 7 )$$

In a preferred embodiment, the sample rate Ts is 0.1 seconds. So, driving a 1 mile course at 10 mph would yield, V₀=10, N=0.1 hr*36000 samples/hr=3600 samples. So, in this case, 1σ error is approximately 0.05%. This puts the 60 error (essentially 100% certainty) at 0.3%, well within the specifications stated above. It should be noted that driving the course at faster speeds increases the accuracy of the distance calculation. For example, if the course were driven at 20 mph instead of 10, then V₀=20, N=1800 and the 1σ error is 0.035%.

Thus, over any reasonable course the error in the accumulated distance can advantageously meet the government specifications. Furthermore, it should be mentioned that, when driving occurs outside of a fixed course the situation improves for several reasons.
Outside of the course the speed samples will tend to vary greatly. Thus ΔV>>e. This improves the approximation of a uniformly distributed rounding error.
The average trip will generally be much greater than 1 mile, thereby improving accuracy according to equation (5).
In normal operation the taximeter only charges based on distance when the vehicle is traveling faster than a minimum speed, usually the speed at which the time rate and the distance rate are equal. This speed is typically between 5-10 mph. Below this speed, the meter charges based on elapsed time. This will tend to increase Vₒ in equation (5) since the average speed is calculated over the charged distance, not the driven distance.
In normal operation the rate that the meter charges includes a minimum amount called the drop distance. This minimum amount covers the first x miles of distance and guarantees that the accuracy of the fare calculation will be based on a minimum distance according to equation (5).

Thus, it can be expected that, in normal operation, the inaccuracy introduced by the rounding error of the OBD speed values will not cause the meter fare calculation to be out of the specified accuracy range.

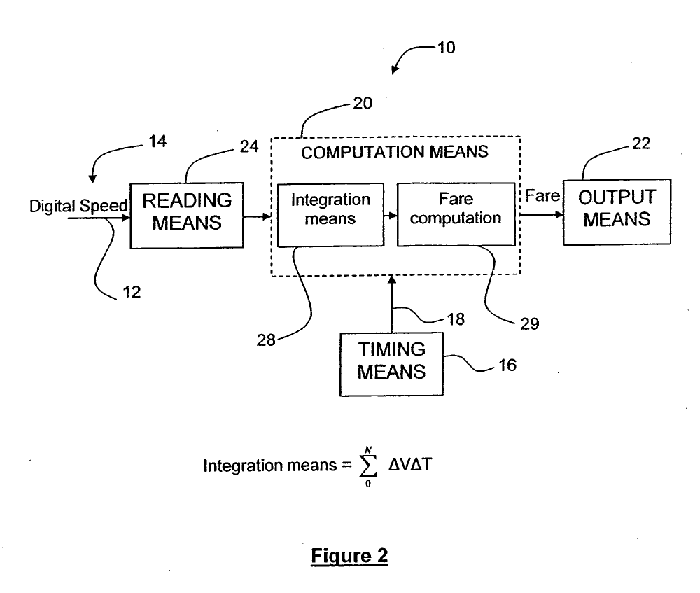

Referring now to FIG. 2, which shows another preferred embodiment of the present invention, the digital taximeter 10 may have as its input digital speed data 14 where the individual words of such speed data may be less accurate than the taximeter specifications. Such a signal is provided by the vehicle OBD connector. In this embodiment the computation means 20 advantageously include integration means 28 (which integrates speed over time in order to determine the distance traveled by the vehicle) as well as fare computation means 29 in order to meet the accuracy specifications as explained in the above mathematics.

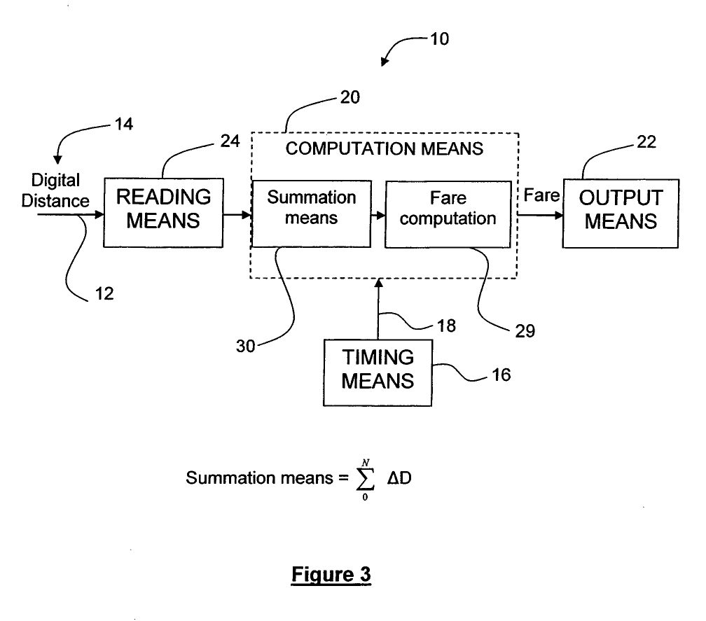

Referring now to FIG. 3, which shows another preferred embodiment of the present invention, the digital taximeter 10 may have as its input digital distance data 14 where the individual words of such distance data may be less accurate than the taximeter specifications. In this embodiment the computation means 20 advantageously include summation means 30 as well as fare computation means 29 in order to meet the accuracy specifications for the taximeter. The summation means 30 achieve this by taking advantage of the random distribution of the driving pattern as shown in the above mathematics.

It should be mentioned that the digital speed or distance input may also be encrypted external to the taximeter and that the taximeter of the present invention would then be advantageously further provided with decryption means (not shown) in order to further increase security and prevent cheating.

It should also be noted that some vehicles or models may have a small but deterministic error in their speed or distance outputs and the taximeter may therefore be advantageously provided with error correction means in order to eliminate or reduce such errors.

In addition to speed or distance data, the taximeter could accept other digital information at its input and such additional input could be used by the taximeter internally to modify it's calculations or provided directly through its output means. An example of the latter would be the vehicle identification number.

Although preferred embodiments of the present invention have been described in detail herein and illustrated in the accompanying drawings, it is to be understood that the invention is not limited to these precise embodiments and that various changes and modifications may be effected therein without departing from the scope or spirit of the present invention.

What is claimed is:

1. An electronic taximeter for a vehicle using a serial bus multi bit digital data signal providing one of speed data and distance data, said taximeter comprising:
a digital input for receiving one of the speed data and distance data;
reading means for reading the digital input;
timing means for providing timing data;
computation means operatively connected to the reading means and the timing means for computing a fare associated with a trip;
output means operatively connected to the computation means for outputting said fare; and
a power source for powering said taximeter.

2. The taximeter according to claim 1, wherein the vehicle is provided with a vehicle electronic bus providing one of said speed data and said distance data.

3. The taximeter according to claim 1, wherein the vehicle is provided with On Board Diagnostic signals providing one of said speed data and said distance data.

4. The taximeter according to claim 3, wherein the vehicle is further provided with an On Board Diagnostic connector providing the On Board Diagnostic signals, the digital input being operatively connected to said connector.

5. The taximeter according to claim 4, wherein the power source is provided by the On Board Diagnostic signals.

6. The taximeter according to claim 1, further comprising at least one additional data input for receiving additional data to either facilitate computation or for outputting said additional data.

7. The taximeter according to claim 1, wherein the digital data signal provides said speed data, the computation means comprising speed integration means for integrating said speed data with respect to time to determine a distance traveled by the vehicle.

8. The taximeter according to claim 7, wherein the vehicle is provided with On Board Diagnostic signals providing said speed data.

9. The taximeter according to claim 1, wherein the digital data signal comprises digital distance data, the computation means comprising distance summation means for summing said distance data to determine a distance traveled by the vehicle.

10. The taximeter according to claim 9, wherein the vehicle is provided with On Board Diagnostic signals providing said distance data.

11. The taximeter according to claim 1, wherein one of said speed data and said distance data are provided from a source external to the vehicle.

12. The taximeter according to claim 1, wherein one of said speed data and said distance data are provided from a Global Positioning System.

13. The taximeter according to claim 1, further comprising encryption means for encrypting the digital data signal prior to the taximeter digital input, and decryption means for decryption after the reading means to enhance protection from cheating.

14. The taximeter according to claim 1, further comprising correction means for reducing deterministic errors in the digital data signal.

15. The taximeter according to claim 1, wherein said output means is a display means.

16. The taximeter according to claim 1, wherein each of said reading means, timing means and computation means are embedded in a single micro-controller.
